(19) United States
(12) Patent Application Publication
(10) Pub. No.: US 2008/0008555 A1
(43) Pub. Date: Jan. 10, 2008

(54) Anchoring device

(76) Inventor: Fergus Johnathan Ardern, Norwich (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/398,475

(22) Filed: Apr. 4, 2006

(30) Foreign Application Priority Data
Apr. 5, 2005 (GB) 0506909.1

(51) Int. Cl. F16B 35/04

(52) U.S. Cl. 411/411

(57) ABSTRACT

An anchoring device comprising a shaft, at least part of whose length comprises a tapered portion, with at least one helical flange which runs substantially along the length of said tapered section and an engagement means to allow the device to engage with a lever wherein in use rotation of the lever about the axis of the shaft results in rotation of the device such that the tapered portion and the helical flange co-operate to drive the device into the ground.

### FIELD OF THE INVENTION

The present invention relates to ground anchors which are generally elongate devices adapted to be inserted into the ground in order to form an anchor point to which other items, such as sign posts, flagpoles or the like can be attached.

### BACKGROUND

One commonly known form of ground anchor comprises a hollow post or hollow rod which is driven into the ground to an appropriate depth. Anchor arms are then extended from the hollow interior into the ground and act to stabilise the post or rod, see GB2216915A. Normally this type of device is driven into the ground using a mallet or the like.

PCT/GB94/00072 discloses a ground anchor for supporting posts or other structures which comprises a tubular socket and a twisted flat bar. In use, a hole is prepared into which the socket is inserted. The end of the bar is then inserted through a slot in the end of the socket and driven into the ground passing through the slot. Wings are also attached to the socket to prevent rotation of the socket once inserted in the ground. To remove the socket from the ground the bar must first be removed before the socket can be removed. No reference is made as to how to remove the socket from the ground.

Ground anchors also exist which can be inserted into the ground using a rotary motion. These devices, which comprise a shaft and blades, act as augers and displace the ground around themselves as they are rotated to generate a hole and thus do not act as a very stable anchor point.

There is therefore a need for a ground anchor which can be driven into the ground without the use of a mallet or the like, which can be easily removed without the need for the use of excessive force and which forms a stable anchor point; such a device is disclosed herein.

### SUMMARY OF THE INVENTION

An anchoring device comprising a shaft, at least part of whose length comprises a tapered portion, with at least one helical flange which runs substantially along the length of said tapered section and an engagement means to allow the device to engage with a lever wherein in use rotation of the lever about the axis of the shaft results in rotation of the device such that the tapered portion and the helical flange co-operate to drive the device into the ground.

The co-operation of the tapered portion and the helical flange is such that the device is actually driven into the ground i.e. is self tapping. The device is driven into the ground by a pulling action generated by the helical flange(s) acting against the ground surrounding the flange(s). It is believed that other anchoring devices, which use a rotational means to drive the anchor in to the ground, actually use an auger type action i.e. they displace the ground around themselves as they are rotated. The invention disclosed herein merely compresses the ground surrounding the device to generate a space appropriately sized for the device. Thus the device disclosed herein can be simply withdrawn from the ground by rotation of a lever in the appropriate direction when engaged with the device. The fact that the ground surrounding the device has not been displaced thus results in a more efficient removal of the device from the ground and additionally forms a more stable anchor in use.

Optionally the tapered section occupies a majority of the length of the shaft. The provision of a large tapered section in this way assists the insertion of the shaft into the ground as the passageway generated by the insertion of the shaft is gradually increased in size.

Optionally the diameter of the helical flange is uniform along the majority of the length of the tapered portion of the shaft. It has been found that this arrangement results in a ground anchor which drives into the ground rather than acting as an auger which displaces the ground around itself.

Preferably a plate is positioned perpendicular to the length of the shaft at or adjacent the end of the device distal from the said tapered portion. In use, once the length of the shaft has been screwed into the ground the plate engages with the ground immediately above the shaft compressing said ground around the device such that the device is more rigidly fixed in place. Additionally the plate improves the stability of the device in the ground by preventing horizontal movement of the device.

Preferably, the anchoring device further comprises a masonry bit attached to the end of the shaft adjacent said tapered portion. The incorporation of a masonry bit in this way enables the device to be used in stony ground without the risk of damage to the end of the shaft entering the ground, which might otherwise be caused by this end striking stones and other such obstructions.

Preferably the shaft further comprises a second tapered section proximal to the end of the shaft distal to the tapered portion wherein the cross-section of the shaft increases in a direction away from the first tapered portion of the shaft. The incorporation of this second tapered section improves the stability of the device once inserted in the ground by further reducing horizontal movement of the device. The incorporation of the second tapered portion of the device is believed to be very important to the effective functioning of the device. It is believed that the second tapered portion compresses the ground surrounding the second tapered portion in an outwards direction (away from the central axis of the device) as the device enters the ground in use.

Preferably the shaft of the device is hollow and further comprises a threaded section in the hollow. In this way a variety of attachment means may be connected to the device and interchanged as required i.e. hooks, cleats and eyelets. The hollow centre of the device provides additional benefits when the device is manufactured from plastics material i.e. the hollow centre of the device increases the rate of cooling of the plastics material after the initial formation of the device such that deformation of the device during the cooling process does not occur.

Preferably small protrusions are present on the first tapered portion of the shaft. The inclusion of small protrusions on the shaft breaks up the ground surrounding the shaft. This reduces the friction between the shaft and the ground such that the force required to drive the device into the ground is reduced.

More preferably the protrusions are pyramidal in shape. Protrusions of this shape have been found to be particularly effective at reducing the force required to drive the device into the ground.

Preferably the device is colour coded. Colour coding can be used to indicate different sizes of device and/or to indicate the thread size of the internal hollow section and/or colour can be used to indicate the purpose for which the device is intended to be used e.g. for use in particularly stony ground or soft ground, or to indicate that the device is intended to be used in combination with other similar devices e.g. to fix a plate to the ground such that a vertical pole such as a signpost can be attached.

Preferably the device incorporates drainage holes to prevent the retention of water in the hollow shaft and/or in the engagement means of the device. The incorporation of such drainage holes prevents the retention of water by the device which might otherwise act as pools which insects such as mosquitoes could utilise for the purpose of reproduction.

Included within the scope of the invention is a ground anchor substantially as described herein with reference to and as illustrated by any appropriate combination of the drawings.

### BRIEF DESCRIPTION OF THE DRAWINGS

The invention will be described by reference to the accompanying drawings in which:

FIG. 1 is a schematic side view of a ground anchor according to the present invention.

FIG. 2 is a schematic perspective end view showing an engagement means according to the present invention.

FIG. 3 is a schematic perspective view of a ground anchor according to the present invention with a fluted shaft and a single helical flange; and

FIG. 4 is a schematic side view of a ground anchor with a fluted shaft and a single helical flange.

FIG. 5 is a schematic side view of a preferred embodiment of a ground anchor according to the present invention incorporating a single helical flange and a hexagonal shaped engagement means.

FIG. 6 is a schematic perspective view of a preferred embodiment of a ground anchor according to the present invention incorporating a single helical flange and a hexagonal shaped engagement means.

FIG. 7 is a schematic perspective view of a preferred embodiment of a ground anchor according to the present invention incorporating a single helical flange and a hexagonal shaped engagement means.

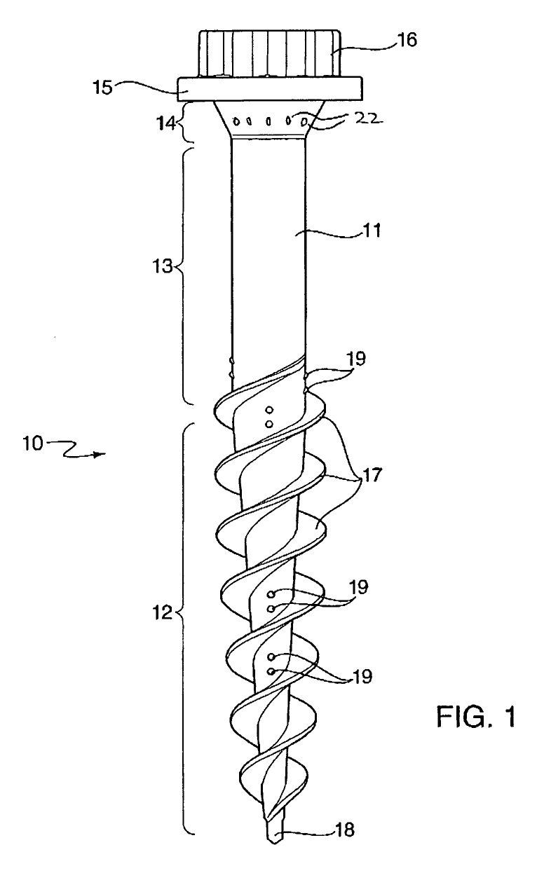

### DESCRIPTION OF THE PREFERRED EMBODIMENT

Wherever possible the same numbers have been used to indicate the same feature on different embodiments of the invention described herein. Reference is initially made to FIG. 1 of the drawings which shows a schematic side view of a ground anchor according to the present invention as generally indicated by 10. The ground anchor comprises a shaft generally indicated by 11, which has a first tapered portion 12, an untapered portion 13 and a second tapered portion 14. The anchor further comprises a plate 15 and an engagement means 16.

The cross-section of the second tapered portion of the shaft 14 increases in diameter in a direction away from the central longitudinal axis of the shaft 11.

Two helical flanges 17 are present along the first tapered portion 12. It will be noted that the first tapered portion 12 and associated helical flange 17 comprise over half, a major part, of the total length of the shaft 11. A masonry bit 18 is attached to the free end of the first tapered portion 12.

The plate 15 is of a wider cross-section, relative to the axis of the shaft than the widest part of the second tapered portion 14. The thickness of the plate 15 is sufficient that it can withstand pressure exerted on it, via the ground, when a rotational force about the axis of the shaft is applied to a lever engaged with the engagement means 16.

The diameter of the helical flanges 17 is uniform along the majority of the length of the first tapered portion 12.

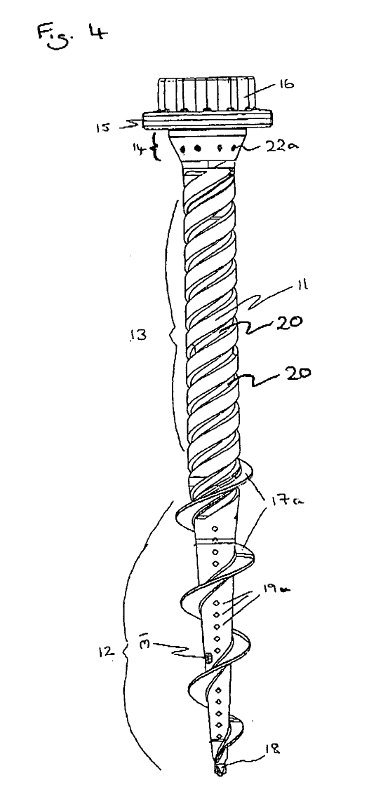

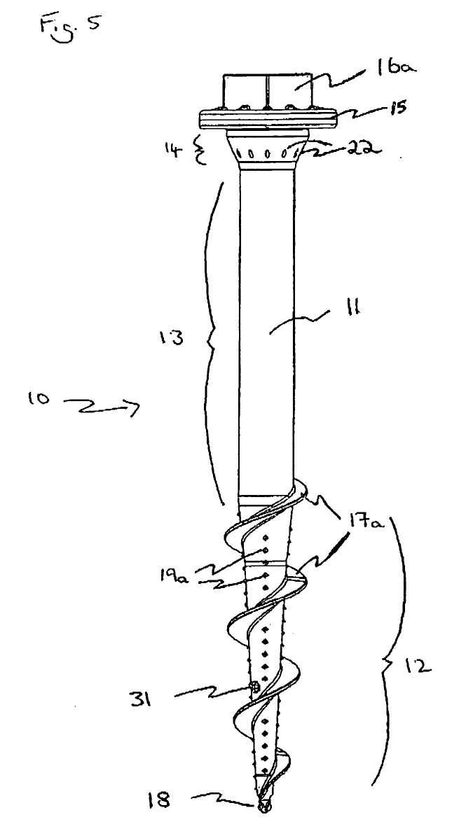

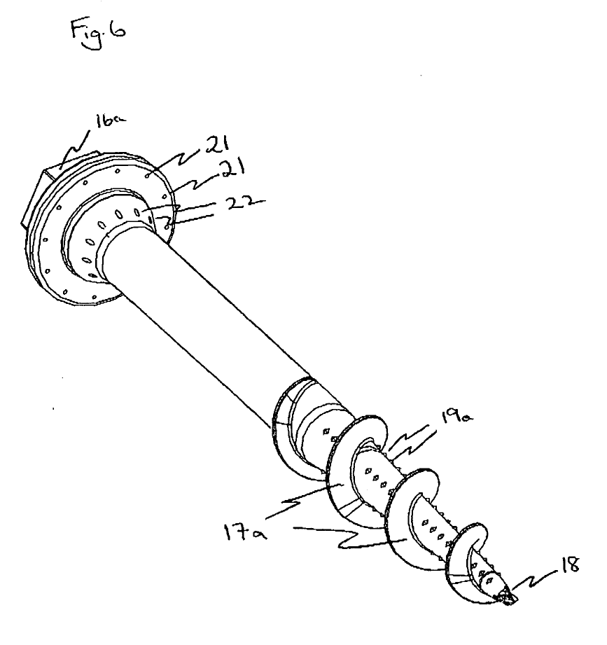

Small protrusions 19 are present on the first tapered portion of the shaft, these may be rounded as shown on FIG. 1 but they are preferentially pyramidal 19a in shape as shown on FIG. 4, FIG. 5 and FIG. 6.

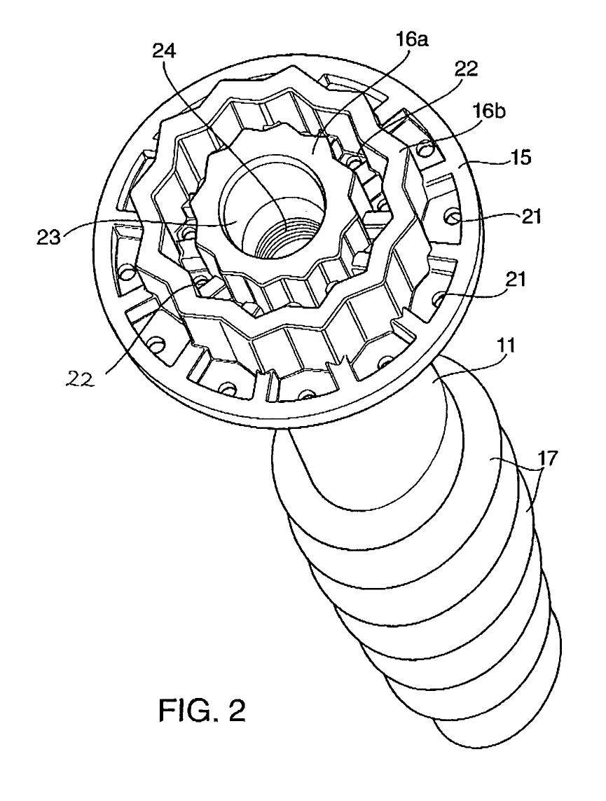

Reference is now made to FIG. 2 of the drawings wherein a schematic perspective end view is provided of the ground anchor shown in FIG. 1.

The engagement means 16a and 16b shown comprises a triple surface engagement means but any suitable engagement means as would be known to a person skilled in the art may be used, e.g. hexagonal nut, star shaped sockets, slots, Philips head etc.

A first set of drainage holes 21 is incorporated into the plate 15 at equal circumferential spacings and a second set of similarly equally circumferentially spaced drainage holes 22 are incorporated between the two parts 16a and 16b of the engagement means. The lower portions of the drainage holes 22 pass through the second tapered portion 14 of the ground anchor, as can be seen on FIG. 1.

The centre of the shaft is hollow, as generally indicated by 23. The hollow section 23 runs down the shaft 11 to the point where the tapered portion 12 begins.

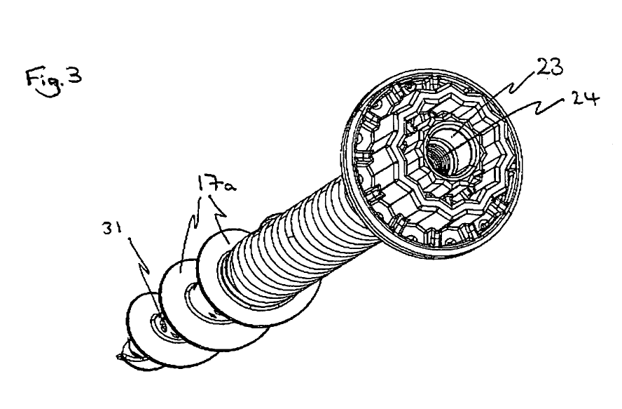

A threaded section 24 is incorporated into the hollow of the shaft 23. A drainage hole 31, as shown on FIG. 3, FIG. 4 and FIG. 5, may be incorporated into the bottom of the hollow shaft 23 or alternatively a plug, not shown, may be provided to block off the hollow shaft when appropriate.

The device (ground anchor) 10 of the present invention may be made from steel, plastics material, aluminium or any other material suitable for the purpose to which the device is to be used. The preferred plastics material used is polypropylene and an especially preferred material used is short glass fibre reinforced polypropylene. The use of short glass fibre reinforced polypropylene gives a ground anchor which is considerably stronger and more hard wearing than devices formed from polypropylene alone.

The use of short glass fibre reinforced polypropylene has the additional benefit that the ground anchor has considerably increased tensile strength at lower temperature i.e. down to, and below 0° C.

A ground anchor formed from short glass fibre reinforced polypropylene which incorporates a masonry bit 18 is capable of being used in much harder material than would otherwise be possible. Such a ground anchor may even be used in concrete provided a bore hole, corresponding to the length of the anchor to be used, is initially drilled in the concrete.

The masonry bit 18 is preferably incorporated into the ground anchor during the moulding process in order to provide maximum strength to the device thus formed.

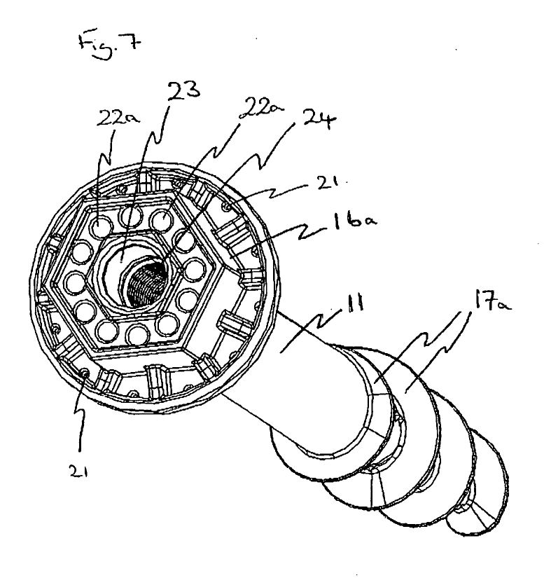

The embodiments shown in FIG. 3, FIG. 4, FIG. 5, FIG. 6 and FIG. 7 utilise a single helical flange 17a which has been found, in use, to be considerably more effective than a device incorporating a double helical flange. The use of a device utilising a double helical flange, as shown in FIG. 1 and FIG. 2, was found to act as an auger displacing the ground around the device in use, particularly when the device was used in soft ground.

The embodiment of the ground anchor shown in FIG. 5, FIG. 6 and FIG. 7 utilises a hexagonal shaped engagement means 16a. A first set of drainage holes 21 is incorporated into the plate 15 at equal circumferential spacings and a second set of similarly equally circumferentially spaced drainage holes 22a are incorporated into the hexagonal shaped engagement means 16a. The lower portion of the drainage holes 22a passing through the second tapered portion 14 of the ground anchor, as can be seen on FIG. 5 and FIG. 6. The incorporation of the first and second set of drainage holes assists in decreasing the weight of the ground anchor disclosed.

In use, the anchoring device is driven into the ground by use of a suitable lever, as would be known to the skilled addressee, which incorporates suitable engagement means to engage with the engagement means 16/16a of the device.

Rotation of the lever, when engaged with the ground anchor, about the axis of the shaft in the appropriate direction causes the tapered portion 12 (of a device incorporating a single helical flange 17a) to co-operate with the helical flange 17a such that the device is driven (i.e. pulled) into the ground by the helical flange 17a. Additionally as the helical flange 17a enters the ground, the ground (when it is a soft material such as soil) surrounding the flange 17a is compressed by the flange 17a as a result of pressure exerted by rotation of the lever.

It is believed as the second tapered portion 14 enters the ground it compresses the surrounding area, in the ground, in an outwards direction (away from the central axis of the ground anchor) as it is pulled into the ground by the helical flange 17a.

The ground anchor is rotated via the lever (and so driven into the ground) until the plate 15 engages with the ground, the force subsequently exerted, results in the plate 15 pressing against the ground such that the ground surrounding the shaft 11 is compacted.

The second tapered portion 14 and the plate 15 thus co-operate to produce a compressed section of ground which surrounds the upper section of the ground anchor ensuring that the anchor (device) 10 is securely fixed in the ground, thus reducing horizontal and vertical movement of the device in use.

The use of a long tapered portion, relative to the overall length of the shaft 11, gives a smooth entry of the device into the ground such that the device is driven (pulled) into the ground (by the helical flange) rather than acting as an auger which displaces the ground around itself. This action is further assisted by the use of a helical flange 17/17a wherein the flange is a uniform diameter along the majority of its length and only narrows at either end. The uniform diameter of the helical flange 17/17a results in the force that drives the anchor into the ground acting over a much larger area than would be the case with a flange which only gradually broadens and then gradually narrows along its length. The anchoring device 10 can be removed by the use of a suitable lever incorporating appropriate engagement means to engage with the engagement means 16/16a of the ground anchor.

The incorporation of a masonry bit 18 allows the device 10 to be used in particularly stony ground without the risk of damaging the tip/end of the device should it strike a stone.

Once driven into the ground, the hollow shaft 24, in combination with the threaded section, provides a means for the attachment of cleats, hooks, eyelets etc., which have complementary threaded sections. Other items such as guide ropes can subsequently be attached to the cleats, hooks, eyelets etc.

It will be appreciated that ground anchors of the type disclosed herein may be used to affix other items to the ground, provided suitable holes are incorporated into the items, or suitable attachment means are used as would be known to the skilled addressee, e.g. to affix the legs of benches to the ground.

The device may further comprise a second helical (fluted) portion 20 formed as a recess in the untapered portion 13, as shown on FIG. 4. Such a recessed helical portion assists the entry of the device (ground anchor) into the ground.

1. An anchoring device comprising a shaft, at least part of whose length comprises a tapered portion, with at least one helical flange which runs substantially along the length of said tapered section and an engagement means to allow the device to engage with a lever wherein in use rotation of the lever about the axis of the shaft results in rotation of the device such that the tapered portion and the helical flange co-operate to drive the device into the ground.

2. An anchoring device as claimed in claim 1 wherein the tapered section occupies a majority of the length of the shaft

3. An anchoring device as either one of claim 1 wherein the diameter of the helical flange is uniform along the majority of the length of the tapered portion of the shaft.

4. An anchoring device as claimed in claim 1 which further comprises a plate positioned perpendicular to the length of the shaft at or adjacent the end of the device distal from the said tapered portion.

5. An anchoring device as claimed in claim 1 which further comprises a masonry bit attached to the end of the shaft adjacent of said tapered portion.

6. An anchoring device as claimed in claim 1 wherein the shaft further comprises a second tapered section proximal to the end of the shaft distal to the tapered portion wherein the cross-section of the shaft increases in a direction away from the first tapered portion of the shaft.

7. An anchoring device as claimed in claim 1 wherein the shaft of the device is hollow and further comprises a threaded section in the hollow.

8. An anchoring device as claimed in claim 1 wherein small protrusions are present on the first tapered portion of the shaft.

9. An anchoring device as claimed in claim 8 wherein the protrusions are pyramidal.

10. An anchoring device as claimed in claim 1 wherein the device is colour coded.

12. An anchoring device as claimed in claim 1 wherein the device incorporates drainage holes to prevent the retention of water in the hollow shaft and/or in the engagement means of the device.
